(19) United States
(12) Patent Application Publication
(10) Pub. No.: US 2018/0149621 A1
(43) Pub. Date: May 31, 2018

(54) METHOD OF NON-DESTRUCTIVE INSPECTION OF A WELD BEAD

(71) Applicant: SAFRAN AIRCRAFT ENGINES, Paris (FR)

(72) Inventors: André CHANDELLE, Saint Aubin Sur Gaillon (FR); Hervé Skrzypczak, Vernon (FR)

(73) Assignee: SAFRAN AIRCRAFT ENGINES, Paris (FR)

(21) Appl. No.: 15/821,117

(22) Filed: Nov. 22, 2017

(30) Foreign Application Priority Data
Nov. 25, 2016 (FR) 1661530

(51) Int. Cl. G01N 29/07; G01N 29/04; G01N 29/22

(52) U.S. Cl. CPC G01N 29/07; G01N 29/043; G01N 2291/102; G01N 2291/267; G01N 29/225

(57) ABSTRACT

A non-destructive method for inspecting a weld bead (18) connecting together two parts (14, 16), a longitudinal direction (X) of the weld bead (18) extending along the interface between the two parts (14, 16), the method comprising providing an emitter (10) and a receiver (12) and taking at least one measurement of a signal emitted by the emitter (10) and received by the receiver (12) after passing through the weld bead (18), wherein the emitter (10) and the receiver (12) are positioned relative to the weld bead (18) in such a manner that the plane containing the axis (A1) of the emitter and the axis (A2) of the receiver is substantially parallel to the longitudinal direction (X).

### CROSS-REFERENCE TO RELATED APPLICATION(S)

This application claims the benefit of priority to French Patent Application No. 1661530, filed on Nov. 25, 2016, the entirety of which is incorporated by reference herein.

### FIELD OF THE INVENTION

The present description relates to a method of non-destructive inspection, and more particularly to a method of non-destructive inspection of a weld bead. Such inspection may be performed in particular with ultrasound.

### TECHNOLOGICAL BACKGROUND

In order to inspect the integrity and the quality of a weld bead, it is known to use methods of non-destructive inspection. For example, in a known method of non-destructive inspection of a weld bead connecting two parts together, the method comprises providing an emitter and a receiver and taking at least one measurement of a signal emitted by the emitter and received by the receiver after passing through the weld bead.

For example, the inspection may be performed using ultrasound with the time of flight diffraction (TOFD) technique, for which the standardized application is defined by the standard NF EN ISO 10863. According to that standard, the ultrasound emitter and the ultrasound receiver are positioned on opposite sides of the weld bead so that the plane connecting their respective axes is perpendicular to the longitudinal direction of the weld bead, which extends along the interface between the two parts. The emitter emits a signal that is received by the receiver after it has passed transversely through the weld bead. In weld beads without defect, the signal received by the receiver is made up of two waves, one travelling at the surface of the weld bead, and the other reflected by the opposite wall of the weld bead. Nevertheless, when a defect such as a crack or a lack of melting is present, the signal is also subjected to diffraction on the ends of said defect. By using the time of flight or travel time of the diffracted signal, the depth of the defect can be calculated in simple manner by trigonometry.

Performing a method of non-destructive inspection by using an emitter that is distinct from the receiver requires the emitter and the receiver to be spaced apart by at least a certain distance. Consequently, in known methods, the parts for inspection need to have space that is accessible and fairly even on opposite sides of the weld bead in order to enable the emitter and the receiver to be passed along opposite sides of the weld bead. It is then sometimes necessary to provide a zone of material that serves only for inspecting the weld bead. Such a requirement is penalizing for designing and sizing the parts, in particular in fields such as aviation or aerospace in which saving weight and material is always a concern.

There therefore exists a need for a novel type of method of non-destructive inspection of a weld bead.

### SUMMARY OF THE INVENTION

To this end, the present disclosure provides a non-destructive method for inspecting a weld bead connecting together two parts, a longitudinal direction of the weld bead extending along the interface between the two parts, the method comprising providing an emitter and a receiver and taking at least one measurement of a signal emitted by the emitter and received by the receiver after passing through the weld bead, wherein the emitter and the receiver are positioned relative to the weld bead in such a manner that the plane containing the axis of the emitter and the axis of the receiver is substantially parallel to the longitudinal direction.

In the meaning of the present disclosure, the term “welding” is used to cover permanently assembling two parts together by supplying them with energy so as to create a joint between the two parts at their common interface. In this disclosure, brazing or soldering is also considered to be a type of welding. Said joint is referred to as a weld bead and may be the result either of adding welding material, or else of melting or of partially sintering the parts to join them together without adding material. The parts may be made of metal but that is not essential, for example they could be made of thermoplastic material or of any material suitable for being welded.

The longitudinal direction may follow a curved line, e.g. when welding together two curved parts, or else a straight line, depending on the shape of the interface between the parts. Locally, the longitudinal direction is transverse to the width of the weld bead, or indeed to the shortest distance between the zones of the two parts that are not thermally transformed by the welding operation.

The emitter and the receiver may be of known, commercially available types. The emitter is spaced apart from the receiver, such that the proposed method differs from so-called “single-probe” methods in which the same probe is both an emitter and a receiver. It is possible to use the emitter and the receiver as per the TOFD method. In the proposed method, the emitter has an axis, also referred to as the emission axis, that may be the axis of a cone in which the signal is emitted. The receiver also presents an axis that may be defined in similar manner. The emitter axis and the receiver axis do not coincide; they thus define a plane, referred to below as the emitter-receiver plane.

In the proposed method, the emitter and the receiver are positioned relative to the weld bead in such a manner that said emitter-receiver plane is substantially parallel to the longitudinal direction. This condition should be assessed locally, between the emitter and the receiver, in particular when the longitudinal direction is curved. In addition, when the longitudinal direction is curved, the emitter-receiver plane cannot be strictly parallel to the longitudinal direction, which is why it is acceptable for the emitter-receiver plane to be substantially parallel to the longitudinal direction.

By means of this characteristic, while performing an inspection, the emitter and the receiver are placed substantially in register with the weld bead, or indeed on the weld bead. Thus, the distance between the emitter and the receiver extends substantially longitudinally relative to the weld bead and no longer transversely, as recommended by the above-specified standard. Consequently, it is possible to reduce significantly or even to eliminate the need for accessible and relatively even space on opposite sides of the weld bead that is required exclusively for inspecting the weld bead. This leads to a saving in the size and the weight of the parts joined together by the weld bead.

In addition, the method presents an additional advantage for certain parts. For example, metal castings often present a structure having large equiaxed grains in which waves are easily refracted, thereby attenuating the emitter signal at each grain boundary. By positioning the emitter-receiver plane substantially parallel to the longitudinal direction, the signal emitted by the emitter passes more through the weld bead than through the parts themselves. As a general rule, the weld bead presents a structure having smaller grains, such that the grain boundaries are less penalizing for signal propagation. The path followed by the signal lies essentially within the weld bead and it therefore attenuates the signal less, thereby making the proposed non-destructive inspection method applicable in circumstances where methods of the prior art, e.g. the methods implementing the directions of the above-mentioned standard, are not satisfactory because of a signal-to-noise ratio that is too small.

In some implementations, the emitter is an ultrasound emitter and the receiver is an ultrasound receiver. Ultrasound is particularly suitable for performing the TOFD method.

The term “substantially” parallel can be understood as meaning that said plane forms an angle relative to the longitudinal direction that is 45° or less, preferably 30° or less, preferably 20° or less, preferably 15° or less, preferably 10° or less, preferably 5° or less.

In some implementations, the non-destructive inspection method comprises taking a plurality of measurements by moving the emitter and the receiver in the longitudinal direction. Movement in the longitudinal direction makes it possible to inspect the entire length of the weld bead. This movement may be performed in discrete manner, at a plurality of locations along the weld bead, or in continuous manner, such as scanning along the bead.

In some implementations, the non-destructive inspection method comprises taking a plurality of measurements by moving the emitter and the receiver transversely relative to the longitudinal direction. Moving transversely to the longitudinal direction makes it possible to inspect the entire width of the weld bead. This movement may be performed in discrete manner, at a plurality of locations across the weld bead, or in continuous manner, such as scanning the width of the bead. Such transverse movement is generally not of any use in the standardized method since under such circumstances, the zone covered by the emitter and the receiver is often wider than the weld bead. The advantage of such movement appears with the method proposed in the present disclosure.

Preferably, while moving the emitter and the receiver, a constant distance and/or orientation is conserved between them.

Thus, in some implementations, the emitter and the receiver are mounted on a common carriage. The carriage forms a support configured in such a manner that the relative distance and orientation of the emitter and the receiver are constant.

In some implementations, the non-destructive inspection method includes machining a surface of the weld bead. The machining seeks to make the surface of the weld bead more regular or less uneven, e.g. to reduce or eliminate the extra thickness of the weld bead relative to the parts. When the method requires contact between the emitter or the receiver and the weld bead, a more regular surface for the weld bead improves the stability of the coupling of the emitter and of the receiver, thereby increasing the accuracy of the measurements, and facilitating any movement of the emitter and/or the receiver in the longitudinal and/or transverse direction.

### BRIEF DESCRIPTION OF THE DRAWINGS

The invention and its advantages can be better understood on reading the following detailed description of embodiments of the invention given as non-limiting examples. The description refers to the accompanying drawings, in which:

FIG. 1 is a schematic section view showing a prior art TOFD method being performed;

FIG. 2 is a schematic view showing how an emitter and a receiver are positioned in a prior art method of non-destructive inspection;

FIG. 3 is a schematic view showing how an emitter and a receiver are positioned in an implementation of a method of non-destructive inspection;

FIG. 4 is an inspection image of a weld bead obtained with the FIG. 2 device; and

FIG. 5 is an inspection image of a weld bead obtained with the FIG. 3 device.

### DETAILED DESCRIPTION OF THE INVENTION

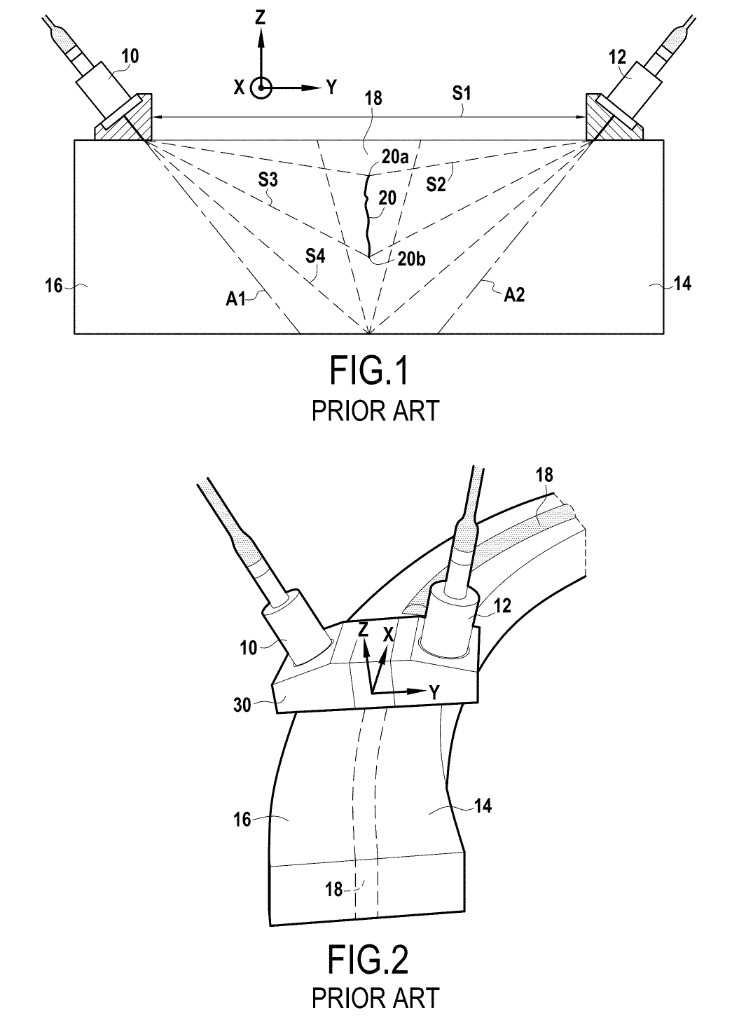

FIG. 1 shows the principle of a method of non-destructive inspection of a weld bead using the time of flight diffraction (TOFD) method of the prior art. Use is made of emitter 10, specifically an ultrasound emitter of and a receiver 12, specifically an ultrasound receiver. The emitter 10 and the receiver 12 are themselves known. The frequency band used may lie in the range 1 megahertz (MHz) to 15 MHz.

Furthermore, a welded assembly comprises two parts 14 and 16 that are united by a weld bead 18. The weld bead 18 may be the result of adding material such as welding material. Alternatively, or in addition, the weld bead 18 may comprise an interface zone between the two parts 14 and 16 that have been melted, brazed, or sintered in that zone. In this example, the weld bead 18 is substantially triangular in section. Nevertheless, any possible shape may be envisaged for the section of the weld bead 18 as a function of the characteristics and the shapes of the parts 14 and 16 for welding together.

As mentioned above, a longitudinal direction X of the weld bead 18 extends along the interface between the two parts 14 and 16. A transverse direction of the weld bead 18 is written Y and a depth direction is written Z. The (X, Y, Z) reference frame is preferably orthogonal. Like the circumferential direction as is well known in cylindrical coordinate systems, the longitudinal direction X designates both the possibly curved line along which the weld bead 18 extends and the tangent at any point to that line.

The weld bead 18 may present a defect 20, specifically in the form of a crack. The defect 20 may also be the result of a lack of melting, a blowhole, a foreign body, a lack of brazing, etc. The defect 20 possesses a first end 20a and a second end 20b.

In the implementation of the method shown in FIG. 1, the emitter 10 and the receiver 12 are placed on opposite sides of the weld bead 18. The emitter 10 possesses an emission axis A1 and the receiver 12 possesses a reception axis A2. The emission axis A1 and the reception axis A2 intersect, such that a signal emitted by the emitter 10 can be received by the receiver 12. In particular, the emission axis A1 and the axis A2 together define an emitter-receiver plane.

As shown in FIG. 1, the emitter-receiver plane is perpendicular to the longitudinal direction X of the weld bead 18. The emitter 10 emits a signal that is received by the receiver 12 after passing transversely through the weld bead 18. Specifically, the signal is made up of two waves S1 and S4 and of two diffracted waves S2 and S3. The first wave S1 travels at the surface of the weld bead 18. A fourth wave S4 is reflected by the wall opposite from the weld bead 18, said wall sometimes being referred to as a “welding lug”. Because of the presence of a defect 20, the signal emitted by the emitter 10 is also subjected to diffraction on the ends of said defect, thereby giving rise to the presence of the waves S2 and S3. The second wave S2 is diffracted by the first end 20a of the defect 20. The third wave S3 is diffracted by the second end 20b of the defect 20.

FIG. 2 also shows the prior art implementation of the TOFD method. The emitter 10 and the receiver 12 are mounted on a carriage 30. Specifically, the parts 14 and 16 are annular, such that the longitudinal direction is curved. As described in detail above, the orientation of the emitter-receiver plane perpendicular to the longitudinal direction requires a large amount of space to be available on opposite sides of the weld bead. In the sample shown in FIG. 2, the carriage 30 projects beyond the parts 14 and 16.

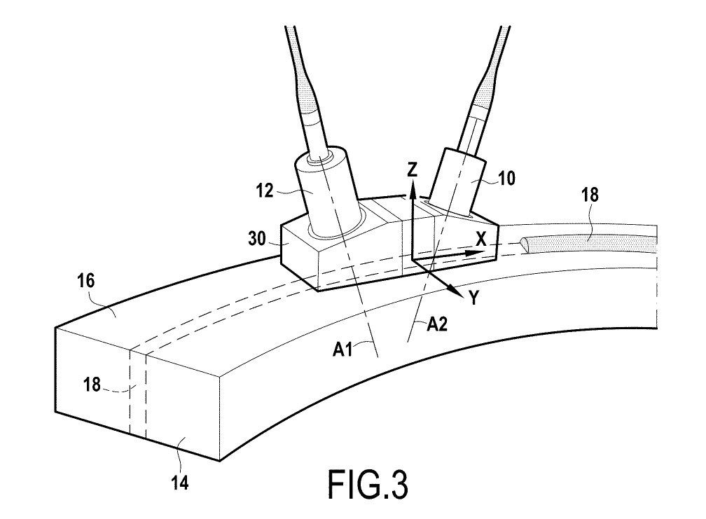

FIG. 3 shows an implementation of a method for non-destructive inspection of a weld bead 18. As mentioned above, the weld bead 18 connects together two parts 14 and 16 and extends in a longitudinal direction X along the interface between the two parts 14 and 16. An emitter 10 and a receiver 12 are provided, and at least one measurement is taken of a signal of the same type as the above-described signals S1, S2, S3, and S4 as emitted by the emitter 10 and received by the receiver 12 after passing through the weld bead 18. The emitter 10, the receiver 12, the parts 14 and 16, and the weld bead 18 may be similar to the above description concerning the prior art.

In contrast, unlike the prior art, and as shown in FIG. 3, the emitter 10 and the receiver 12 are positioned relative to the weld bead 18 in such a manner that the plane containing the emitter axis A1 and the receiver axis A2 is substantially parallel to the longitudinal direction X. Thus, the signal passes longitudinally through the weld bead 18. Specifically, the longitudinal direction X is curved. The parallel configuration between the emitter-receiver plane and the longitudinal direction should be assessed locally. In any event, said plane forms an angle relative to the longitudinal direction X that is 45° or less, preferably 30° or less, preferably 20° or less, preferably 15° or less, preferably 10° or less, preferably 5° or less.

Furthermore, the emitter 10 and the receiver 12 in this example are mounted on a common carriage 30. Thus, the relative distance and orientation of the emitter 10 and the receiver 12 are constant.

As can be seen easily by comparing FIG. 3 with FIG. 2, the space occupied transversely by the emitter 10 and the receiver 12, and by extension by the carriage 30, relative to the parts 14 and 16 is much less than in the prior art method since this space extends longitudinally over the weld bead 18.

As mentioned above, several measurements may be taken, e.g. by moving the emitter 10 and the receiver 12 in the longitudinal direction X and/or in the transverse direction Y. In an example, the carriage 30 is moved in discrete manner along the direction X, and at regular intervals the carriage 30 is moved in continuous manner along the direction Y, across the thickness of the weld bead 18. The movement of the emitter 10 and of the receiver 12, or indeed of the carriage 30, may be automated and/or controlled by a robot or by a computer.

The signals S1, S2, S3, and S4 received by the receiver 12 may be processed by processing software of known type, sometimes referred to as imaging software, so as to obtain a graphical representation of defects detected between the emitter 10 and the receiver 12.

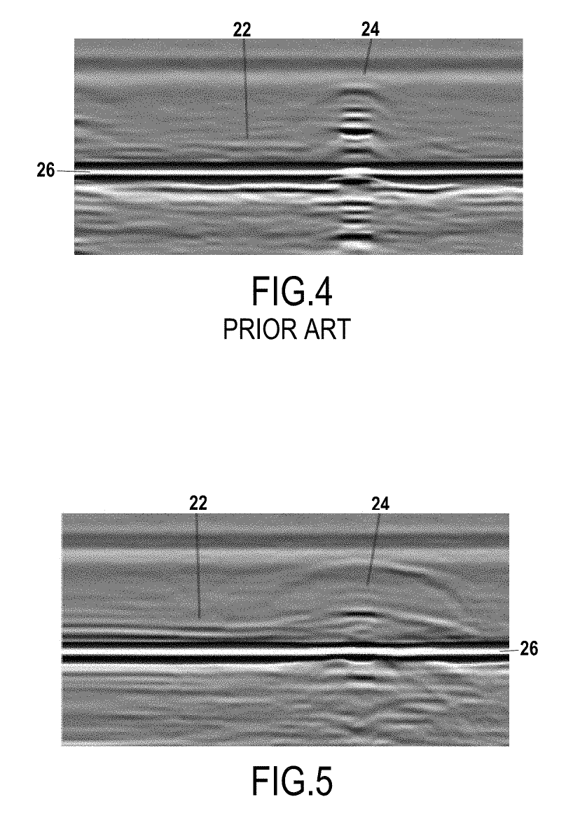

FIGS. 4 and 5 are images obtained by using such imaging software. FIG. 4 was obtained using the prior art TOFD method, i.e. with the emitter-receiver plane perpendicular to the longitudinal direction (FIG. 2), while FIG. 5 was obtained by implementing the method shown in FIG. 3, i.e. by positioning the emitter 10 and the receiver 12 so that the emitter-receiver plane is substantially parallel to the longitudinal direction. FIGS. 4 and 5 were obtained using the same emitter 10 and the same receiver 12 on the same weld bead 18, the only difference being the positioning of the emitter 10 and of the receiver 12 relative to said weld bead 18.

In FIG. 4, a person skilled in the art will recognize undulations 22. These undulations represent an echo due to the lack of ultrasound penetration and they are symptomatic of a lack of melting in the weld bead 18. Fringes 24 can also be recognized that are representative of an orifice. Specifically, said orifice is a reference hole that serves to verify proper operation of the emitter 10 and the receiver 12, and also of their sensitivity. For example, the size of the hole may be representative of the size of the smallest defect that it is desired to detect, typically 1 millimeter (mm) to 2 mm. Finally, on the sample in question, the image also includes a strip 26 representative of the weld lug.

As can be seen in FIG. 5, the undulations 22, the fringes 24, and the strip 26 are also visible, possibly in a somewhat modified form, in an image obtained while the emitter-receiver plane is substantially parallel to the longitudinal direction. The change in the shape of the undulations 22 and of the fringes 24 is due to the change in the position and the orientation of the emitter 10 and of the receiver 12 relative to the defects represented by these undulations 22 and fringes 24. The contrast of the defects can be considered to be less good than in the prior art, and that might appear, a priori, to be unacceptable for the person skilled in the art. Nevertheless, the inventors have shown that said defects are nevertheless well detected in spite of using the new method, typically a use that is not in compliance with the above-mentioned standard. The method proposed in the present disclosure is thus entirely suitable for replacing existing methods, and it offers greater freedom when designing the parts 14 and 16.

When at least one of the emitter 10, the receiver 12, and the carriage 30 rests on the surface of the weld bead 18 during inspection, it may be advantageous prior to taking measurements, to machine a surface of the weld bead 18. The machining may be performed in known manner so as to obtain a plane surface for the weld bead 18, or indeed for the weld bead 18 and for zones of the parts 14 and 16 adjacent to the weld bead 18 (see FIG. 3). This guarantees a constant angle of incidence for the emitter 10 relative to the weld bead, and also low amplitudes for interfering echoes.

Although the emitter 10 and the receiver 12 are always shown as being in contact with the weld bead 18, e.g. via the carriage 30, it is possible to provide a gap between the emitter 10 and the weld bead 18, or indeed between the receiver 12 and the weld bead 18. Making a support that is suitable for guaranteeing accurate measurements and good positioning of the emitter 10 and the receiver 12 relative to the weld bead 18 comes within the competence of the person skilled in the art.

Although the present invention is described with reference to specific implementations, modifications may be provided thereto without going beyond the general ambit of the invention as defined by the claims. In particular, individual characteristics of the various implementations shown and/or mentioned may be combined in additional implementations. Consequently, the description and the drawings should be considered in a sense that is illustrative rather than restrictive.

We claim:

1. A non-destructive method for inspecting a weld bead connecting together two parts, the method using the time of flight diffraction technique, a longitudinal direction of the weld bead extending along the interface between the two parts, the method comprising providing an emitter and a receiver and taking at least one measurement of a signal emitted by the emitter and received by the receiver after passing through the weld bead, wherein the emitter and the receiver are positioned relative to the weld bead in such a manner that the plane containing the axis of the emitter and the axis of the receiver is substantially parallel to the longitudinal direction.

2. A non-destructive inspection method according to claim 1, wherein the emitter is an ultrasound emitter and the receiver is an ultrasound receiver.

3. A non-destructive inspection method according to claim 1, comprising taking a plurality of measurements by moving the emitter and the receiver in the longitudinal direction.

4. A non-destructive inspection method according to claim 1, comprising taking a plurality of measurements by moving the emitter and the receiver transversely relative to the longitudinal direction.

5. A non-destructive inspection method according to claim 1, wherein the emitter and the receiver are mounted on a common carriage.

6. A non-destructive inspection method according to claim 1, including machining a surface of the weld bead.
